(19) United States
(12) Patent Application Publication
(10) Pub. No.: US 2014/0014200 A1
(43) Pub. Date: Jan. 16, 2014

(54) THROUGHFLOW RATE LIMITING DEVICE

(71) Applicants: Martin Atzwanger, Gleisdorf (AT); Heinz Petutschnig, Judendorf-Strassengel (AT)

(72) Inventors: Martin Atzwanger, Gleisdorf (AT); Heinz Petutschnig, Judendorf-Strassengel (AT)

(21) Appl. No.: 13/983,560

(22) PCT Filed: Feb. 2, 2012
(86) PCT No.: PCT/EP2012/051778

§ 371 Date: Oct. 3, 2013

(30) Foreign Application Priority Data
Feb. 3, 2011 (AT) A 144/2011

(51) Int. Cl. F16K 17/30

(52) U.S. Cl. CPC F16K 17/30
USPC 137/504

(57) ABSTRACT

A throughflow rate limiting device with a spring-loaded valve body which is disposed upstream of a cross-sectional constriction in a flow duct so as to be axially slideable between a first and a second position. The valve body is loaded by a spring in the direction of the first position, and for a given pressure gradient throughflow in the first position is greater than in the second position. The cross-sectional constriction may be bypassed by at least one bypass line which branches off from the flow duct upstream of the cross-sectional constriction and rejoins the flow duct downstream of the cross-sectional constriction. In order to achieve small flow resistance in the open state and abrupt switching, the valve body has the shape of a double cone.

### CROSS-REFERENCE TO RELATED APPLICATIONS

The present application is a National Stage Application of PCT International Application No. PCT/EP2012/051778 (filed on Feb. 2, 2012), under 35 U.S.C. §371, which claims priority to Austrian Patent Application No. A 144/2011 (filed on Feb. 3, 2011), which are each hereby incorporated by reference in their respective entireties.

### TECHNICAL FIELD

The invention relates to a throughflow rate limiting device with a spring-loaded valve body which is disposed upstream of a cross-sectional constriction in a flow duct so as to be axially slideable between a first and a second position, where the valve body is loaded by a spring in the direction of the first position and where for a given pressure gradient throughflow in the first position is greater than in the second position, and where the cross-sectional constriction may be bypassed by at least one bypass line, which branches off from the flow duct upstream of the cross-sectional constriction and rejoins the flow duct downstream of the cross-sectional constriction.

### BACKGROUND

From EP 0 969 233 A1 there is known a throughflow limiter with a spring-loaded valve body, where the spring-loaded valve body is located in a constricted part of the flow duct. The nozzle-shaped wall of the housing is provided with longitudinal ribs, which in the closed state of the valve body form flow channels permitting restricted throughflow in the closed position of the valve body.

Throughflow limiting devices with a cross-sectional constriction which can be bypassed by a bypass line, are known from U.S. Pat. Nos. 4,437,493 A, 4,699,166 A and 3,122,162 A.

It is a disadvantage that throughflow limiters of this kind incur relatively high pressure losses in the open state. It is also disadvantageous that known throughflow limiters will switch from the first to the second position only when pressure differences are relatively high. The switching point thus lies at a relatively high pressure difference level.

It is of further disadvantage that known throughflow limiters show relatively strong hysteresis, i.e., the opening movement of the valve body from the closed position is greatly retarded.

### SUMMARY

It is the object of the present invention to avoid these disadvantages and to configure a throughflow limiting device which has little pressure loss in the open position and little response retardation.

According to the invention this object is achieved by proposing that the valve body have the shape of a double cone. The double-conical shape will result in a design with very small flow losses.

The bypass line may be disposed outside of the flow duct in the housing of the throughflow limiting device.

To permit fast opening from the second position it is of advantage if the valve body is guided by a fixed axial guiding rod, which guiding rod may be provided with a preferably adjustable stop downstream of the valve body, against which the valve body will rest in the second position. The stop may for instance be configured as a sleeve which is axially adjustable on the guiding rod. The sleeve at the same time acts as a counter-bearing for the spring. The sleeve may thus be used both to axially adjust the stop for the valve body and to adjust the preloading of the spring.

When the defined throughflow rate is reached the throughflow limiting device of the invention will abruptly and automatically switch, without external intervention or actuation, the switching force necessary to actuate the valve being entirely derived from flow-dynamical effects.

The defined stop on the guiding rod will prevent the valve body from closely pressing against the housing in its second position. In the second position there will thus remain a defined gap between the valve body and the inner wall of the housing, which will enable very fast opening of the valve body departing from the second position. The inner wall of the housing, which tapers in flow direction, may be configured as a cone or may be nozzle-shaped.

Particularly low flow losses may be achieved if the rotationally symmetrical valve body has a non-linear curve as generatrix. This will permit particularly low throughflow losses in the open state of the throughflow limiting device designed according to the invention.

In a particularly preferred variant it is provided that the switching point between the first and second position is reached when the pressure difference between an area of the flow duct upstream of the throughflow limiting device and an area downstream of the throughflow limiting device is not more than 500 mbar, preferably at most 200 mbar. This will result in a very sensitive response behaviour with little retardation. By comparison, known throughflow limiters usually switch only when a pressure difference of approximately 1,000 mbar has been reached.

Essentially the switching point is determined by the flow-optimized shape of the valve body and the surrounding housing and by the chosen spring force. The switching forces are derived entirely from flow-dynamical effects. In order to achieve only small pressure losses the switching force must be amplified via these flow-dynamical effects. By designing the throughflow limiting device according to the invention the switching point can be realised at a very small pressure difference and completely without actuating means.

### DRAWINGS

The invention will now be described in more detail with reference to the enclosed drawings. There is shown:

FIG. 1 illustrates a longitudinal section of a throughflow limiting device in accordance with embodiments of the invention.

FIG. 2 illustrates a diagram of pressure loss versus mass flow.

### DESCRIPTION

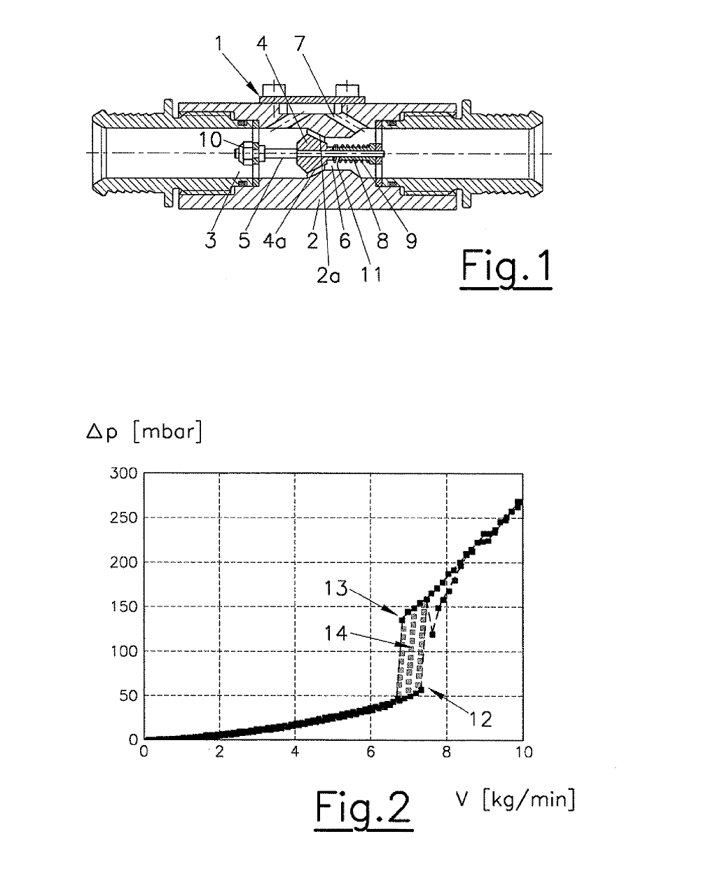

The throughflow limiting device 1 illustrated in FIG. 1 has a housing 2 with a flow duct 3 in which is disposed a valve body 4 in the area of a nozzle-shaped cross-sectional constriction, said valve body 4 being axially slideable on a fixed guiding rod 5.

The valve body 4 and the cross-sectional constriction 6 can be bypassed by a bypass line 7, which branches off from the flow duct 3 upstream of the valve body 4 and rejoins the flow duct 3 downstream of the cross-sectional constriction 6.

The guiding rod 5 is provided with a sleeve 8 on which is borne a spring 9 which preloads the valve body 4 in a first position shown in FIG. 1. A fastening nut for the guiding rod 5 is referenced by numeral 10.

The valve body 4 is essentially designed as a double cone to achieve minimal flow losses.

The sleeve 8 acts as a stop 11 for the valve body 4, the valve body 4 resting against the stop 11 in the second position. The stop 11 is adjusted via the sleeve 8 in such a way that in the second position of the valve body 4 a defined gap is left open between the conical surface 4a of the valve body 4 and a conical wall surface 2a of the housing 2. This gap enables fast opening of the valve body 4 from the second position, such that only little hysteresis will occur. The remaining gap may have non-constant width due to the design of the wall surface 4a of the valve body 4 and the wall surface 2a of the housing 2.

In the first position of the valve body 4 illustrated in FIG. 1 a large amount of the flow medium flows past the valve body 4 while a smaller amount flows through the bypass line 7. At a certain pressure difference Δp defined by the spring 9 the valve body 4 is abruptly shifted from the first to the second position, thus closing the flow duct 3 save for a small gap remaining between the wall surfaces 4a and 2a. The larger part of the flow medium will now flow through the bypass line 7 avoiding the valve body 4 and entering the flow duct 3 again downstream of the cross-sectional constriction 6.

In FIG. 2 pressure difference Δp is plotted over flow volume V. Reference number 12 indicates the closing point of the valve body 4, reference number 13 the opening point of the valve body 4. Up to the closing point the device shows relatively small flow resistance. The switching process abruptly increases flow resistance, thus providing the desired limiting of flow. The switching point lies at approximately 20 mbar to 200 mbar pressure difference between the upstream and the downstream region of the flow duct 3.

As can be seen, the closing/opening characteristic of the valve body 4 is subject to hysteresis. Hysteresis between opening and closing of the valve body 4 is indicated by reference numeral 14. On account of the defined gap in the second position between the valve body 4 and the bypass line 7 hysteresis 14 may be kept at a minimum. Due to the defined gap a small flow is possible even when the valve body 4 is “closed.”

1-12. (canceled)

13. A throughflow rate limiting device comprising:
a housing;
a flow duct in the housing and having a cross-sectional constriction;
a valve body having a double cone cross-section which is disposed in the flow duct upstream of the cross-sectional constriction and axially slideable between a first position and a second position;
a spring configured to load the valve body in a first direction to the first position; and
at least one bypass line in fluidic communication with the flow duct and which bypasses the cross-sectional constriction, and branches off from the flow duct upstream of the cross-sectional constriction at a first region of the flow duct and rejoins the flow duct downstream of the cross-sectional constriction at a second region of the flow duct,
wherein, for a given pressure gradient, throughflow through the flow duct is greater when the valve body is in the first position than in the second position.

14. The throughflow rate limiting device of claim 13, wherein the bypass line is located outside of the flow duct in the housing.

15. The throughflow rate limiting device of claim 13, further comprising a fixing guiding rod configured to guide the valve body through the flow duct.

16. The throughflow rate limiting device of claim 15, further comprising a stop in the flow duct downstream of the valve body and against which the valve body rests when in the second position.

17. The throughflow rate limiting device of claims 16, wherein the stop is moveably adjustable.

18. The throughflow rate limiting device of claim 17, wherein the stop comprises a sleeve mounted on the guiding rod.

19. The throughflow rate limiting device of claim 18, wherein the sleeve acts as a counter bearing for the spring.

20. The throughflow rate limiting device of claim 13, wherein a defined gap between the valve body and the housing is made when the valve body is in the second position.

21. The throughflow rate limiting device of claim 13, wherein a region of the housing has a conical wall surface at least partially surrounding the valve body.

22. The throughflow rate limiting device of claim 13, wherein the valve body is rotationally symmetrical.

23. The throughflow rate limiting device of claim 22, wherein the valve body has an outer surface whose generatrix comprises a non-linear curve.

24. The throughflow rate limiting device of claim 13, wherein the housing has at least one rotationally symmetrical wall surface at least partially surrounding the valve body, whose generatrix is a non-linear curve.

25. The throughflow rate limiting device of claim 13, wherein a switching point between the first position and the second position is set at a pressure difference between a region of the flow duct upstream of the throughflow rate limiting device and a region of the flow duct downstream of the throughflow rate limiting device.

26. The throughflow rate limiting device of claim 13, wherein the pressure difference is no greater than 500 mbar.

27. The throughflow rate limiting device of claim 13, wherein the pressure difference is no greater than 200 mbar.

28. A throughflow rate limiting device comprising:
a flow duct having a cross-sectional constriction;
a valve body having a double cone cross-section which is disposed in the flow duct upstream of the cross-sectional constriction and axially slideable between a first position and a second position;
a spring configured to load the valve body in a first direction to the first position; and
a bypass line in fluidic communication with the flow duct and which bypasses the cross-sectional constriction,
wherein throughflow through the flow duct is greater when the valve body is in the first position than when the valve body is in in the second position.

29. The throughflow rate limiting device of claim 28, further comprising a fixing guiding rod configured to guide the valve body through the flow duct.

30. The throughflow rate limiting device of claim 29, further comprising a stop in the flow duct downstream of the valve body and against which the valve body rests when in the second position.

31. The throughflow rate limiting device of claims 30, wherein the stop is moveably adjustable.

32. The throughflow rate limiting device of claim 31, wherein the stop comprises a sleeve mounted on the guiding rod.
